(19) United States
(12) Patent Application Publication
(10) Pub. No.: US 2023/0404358 A1
(43) Pub. Date: Dec. 21, 2023

(54) FLUID LEVEL SENSOR ASSEMBLY AND ON-DEMAND GLASSWASHER INCORPORATING THE SAME

(71) Applicant: Moyer Diebel Ltd., Jordan Station (CA)

(72) Inventors: Raymond Charles HOWE, Grimsby (CA); Ivan Josip KATKIC, Oakville (CA); Ryan John MCMILLAN, Ariss (CA); Lester David SWANSON, Kitchener (CA)

(73) Assignee: Moyer Diebel Ltd., Jordan Station, ON (CA)

(21) Appl. No.: 18/334,495

(22) Filed: Jun. 14, 2023

Related U.S. Application Data
(60) Provisional application No. 63/353,052, filed on Jun. 17, 2022.

(51) Int. Cl. A47L 15/42

(52) U.S. Cl. CPC A47L 15/4244; A47L 15/4278; A47L 15/4217; A47L 15/4223; A47L 15/4297; G01F 23/296

(57) ABSTRACT

An on-demand glasswasher comprises a wash tank; a fluid level sensor assembly that includes an ultrasonic sensor assembly positioned within the wash tank; at least one microprocessor connected to the ultrasonic sensor assembly; and a memory device coupled to the at least one microprocessor, the memory device storing processor-executable instructions which, when executed by the at least one microprocessor, configure the microprocessor to receive, from the ultrasonic sensor assembly, ultrasonic signals; and analyze the ultrasonic signals to determine a level of fluid in the wash tank.

### CROSS-REFERENCE TO RELATED APPLICATIONS

This application claims the benefit of U.S. Provisional Application No. 63/353,052 filed on Jun. 17, 2022, the entire contents of which are incorporated herein by reference.

### TECHNICAL FIELD

The present disclosure relates to a fluid level sensor assembly and an on-demand glasswasher incorporating the same.

### BACKGROUND

Fluid level sensor assemblies are used to measure fluid levels in a vessel such as for example a tank. Oftentimes, these fluid level sensor assemblies are inaccurate due to contaminants or inconsistencies within the fluid of the tank. Further, these fluid level sensor assemblies often do not provide any information other than the fluid level. For example, these fluid level sensors do not provide additional details regarding the fluid in the vessel.

### BRIEF DESCRIPTION OF THE DRAWINGS

Embodiments are described in detail below, with reference to the following drawings:

FIG. 1 is an isometric view of an on-demand glasswasher;

FIG. 2 is a schematic view showing various components of the on-demand glasswasher of FIG. 1;

FIG. 3 is a schematic view of a wash system forming part of the on-demand glasswasher of FIG. 1;

FIG. 4 is a partial schematic view of a fluid level sensor assembly forming part of the on-demand glasswasher of FIG. 1;

FIG. 5 is an isometric view of the fluid level sensor assembly of FIG. 4;

FIG. 6 is a sectional view showing a nozzle and an ultrasonic sensor assembly forming part of the fluid level sensor assembly of FIG. 4;

FIG. 7 is a cross-sectional view of an ultrasonic sensor assembly forming part of the fluid level sensor assembly of FIG. 4;

FIG. 8 is an isometric view of a harbour tube forming part of the fluid level sensor assembly of FIG. 4;

FIG. 9 is a schematic view of a rinse system forming part of the on-demand glasswasher of FIG. 1;

FIG. 10 is a top plan view of a motor and conveyor system forming part of the on-demand glasswasher of FIG. 1;

FIG. 11 is a side view of a stop forming part of the on-demand glasswasher of FIG. 1;

FIG. 12 is an isometric view of a cylinder forming part of the on-demand glasswasher of FIG. 1;

FIG. 13 is a top plan view of the on-demand glasswasher of FIG. 1;

FIG. 14 is a flowchart showing operations performed by a microprocessor to fill a wash tank forming part of the on-demand glasswasher of FIG. 1;

FIG. 15 is a partial schematic view of another embodiment of a fluid level sensor assembly;

FIG. 16A is a cross-sectional view of an intermediary or settling chamber forming part of another embodiment of a fluid level sensor assembly;

FIG. 16B is another cross-sectional view of the intermediary or settling chamber of FIG. 16A;

FIG. 17 is a graph showing example fluid level, wash pump, echo, fluid level display counts and fluid signal quality signals obtained during use of an on-demand glasswasher; and

FIG. 18 is another graph showing example fluid level, hot water, drain, echo, fluid level display counts and fluid signal quality signals obtained during use of an on-demand glasswasher.

Like reference numerals are used in the drawings to denote like elements and features.

### DETAILED DESCRIPTION OF VARIOUS EMBODIMENTS

Accordingly, in one aspect there is provided an on-demand glasswasher comprising a wash tank; a fluid level sensor assembly that includes an ultrasonic sensor assembly positioned within the wash tank; at least one microprocessor connected to the ultrasonic sensor assembly; and a memory device coupled to the at least one microprocessor, the memory device storing processor-executable instructions which, when executed by the at least one microprocessor, configure the microprocessor to receive, from the ultrasonic sensor assembly, ultrasonic signals; and analyze the ultrasonic signals to determine a level of fluid in the wash tank.

In one or more embodiments, the processor-executable instructions, when executed by the at least one microprocessor, further configure the at least one microprocessor to compare the level of fluid in the wash tank to a threshold; and responsive to determining that the level of fluid in the wash tank is less than the threshold, send a signal causing a valve to open to fill the wash tank.

In one or more embodiments, the processor-executable instructions, when executed by the at least one microprocessor, further configure the at least one microprocessor to compare the level of fluid in the wash tank to a threshold; and responsive to determining that the level of fluid in the wash tank is equal to or greater than the threshold, send a signal causing a valve to close to stop filling the wash tank.

In one or more embodiments, the processor-executable instructions, when executed by the at least one microprocessor, further configure the at least one microprocessor to engage a fluid level prediction engine to predict a level of fluid in the wash tank; determine that a difference between the level of fluid in the wash tank and the predicted level of fluid in the wash tank is greater than a threshold; and responsive to determining that the difference between the level of fluid in the wash tank and the predicted level of fluid in the wash tank is greater than the threshold, perform at least one of sending a signal causing a valve to close or sending a signal to output an alert.

In one or more embodiments, the fluid level prediction engine predicts the level of fluid in the wash tank based on at least one of time and flow rate.

In one or more embodiments, the processor-executable instructions, when executed by the at least one microprocessor, further configure the at least one microprocessor to analyze the ultrasonic signals to determine a contamination level of the fluid in the wash tank; determine that the contamination level is greater than a threshold; and responsive to determining that the contamination level is greater than the threshold, send one or more signals to perform a wash refresh sequence

In one or more embodiments, when performing the wash refresh sequence, the processor-executable instructions, when executed by the at least one microprocessor, further configure the at least one microprocessor to send a signal to halt operation of the on-demand glass washer; send a signal to open a drain to drain out fluid from the wash tank; send a signal to close the drain; send a signal to open one or more valves to fill the wash tank; determine that a level of fluid in the wash tank is equal to a threshold; send a signal to close the one or more valves; and send a signal to resume normal operation of the on-demand glass washer.

In one or more embodiments, the ultrasonic sensor assembly operates as a turbidity sensor to determine a soil level of fluid in the wash tank.

In one or more embodiments, the processor-executable instructions, when executed by the at least one microprocessor, further configure the at least one microprocessor to determine that a quality of the ultrasonic signals or an amount of the ultrasonic signals received has decreased; responsive to determining that the quality of the ultrasonic signals or the amount of the ultrasonic signals has decreased, send a signal to drain an amount of fluid from the wash tank; and responsive to draining the amount of fluid, send a signal to fill the wash tank with the amount of fluid.

In one or more embodiments, the amount of fluid drained from the wash tank is dependent on an approximate percentage of ultrasonic signals received.

In one or more embodiments, the processor-executable instructions, when executed by the at least one microprocessor, further configure the at least one microprocessor to determine a soil level of the fluid in the wash tank based on the quality of the ultrasonic signals or the amount of the ultrasonic signals.

In one or more embodiments, the on-demand glasswasher further comprises at least one nozzle positioned above the wash tank at a height greater than a maximum fill level of the wash tank, the at least one nozzle in fluid communication with a valve to selectively fill the wash tank with fluid.

In one or more embodiments, the fluid level sensor assembly further comprises a harbour tube located within the wash tank, wherein the ultrasonic sensor assembly is positioned within the harbour tube.

In one or more embodiments, the fluid level sensor assembly further comprises an intermediary chamber that includes an inlet for receiving fluid from a fluid source and an outlet in fluid communication with the harbour tube for directing the egress of fluid from the intermediary chamber to the harbour tube.

In one or more embodiments, the intermediary chamber includes an interior wall defining a serpentine fluid channel between the inlet and the outlet.

According to another aspect there is provided a fluid level sensor assembly comprising a harbour tube having a notch defined in a first end thereof; and an ultrasonic sensor assembly positioned within the harbour tube adjacent to the first end thereof.

In one or more embodiments, the ultrasonic sensor assembly emits ultrasonic signals from the first end of the harbour tube towards a second end of the harbour tube.

In one or more embodiments, the ultrasonic sensor assembly receives reflected ultrasonic signals and communicates the received reflected ultrasonic signals to a microprocessor for processing to determine a fluid level within the harbour tube.

In one or more embodiments, the fluid level sensor assembly further comprises an intermediary chamber that includes an inlet that receives fluid from a fluid source and an outlet in fluid communication with the harbour tube that directs the egress of fluid from the intermediary chamber to the harbour tube.

In one or more embodiments, the intermediary chamber includes an interior wall defining a serpentine fluid channel between the inlet and the outlet.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

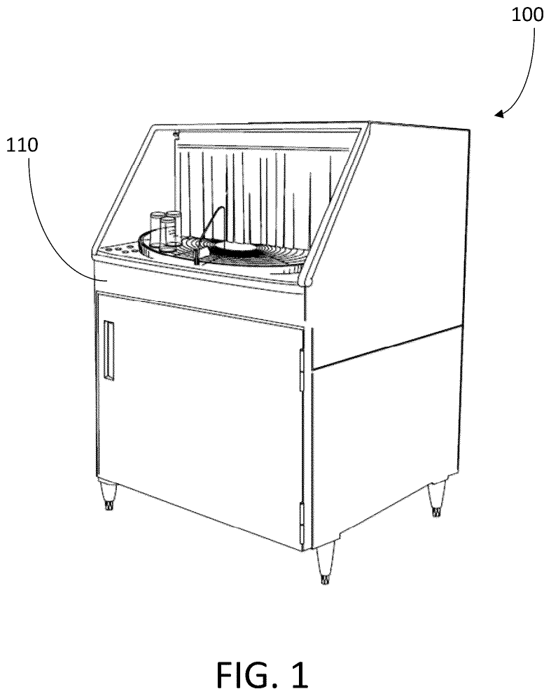

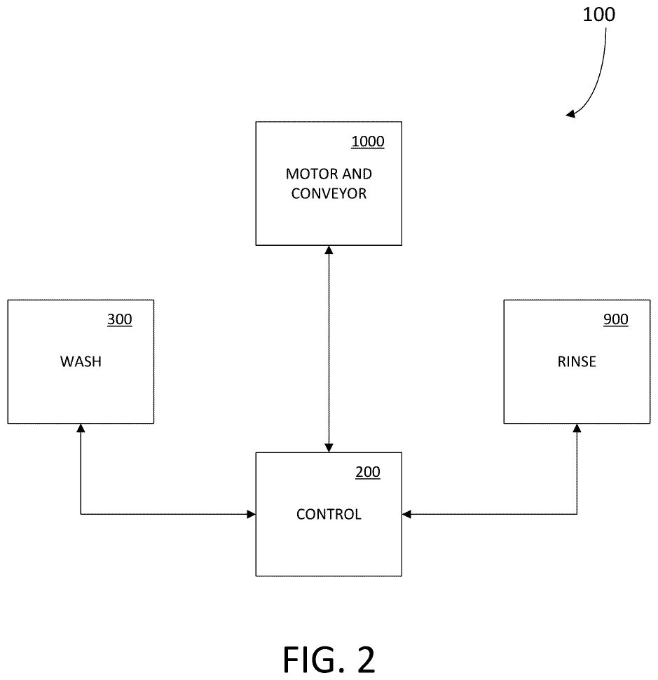

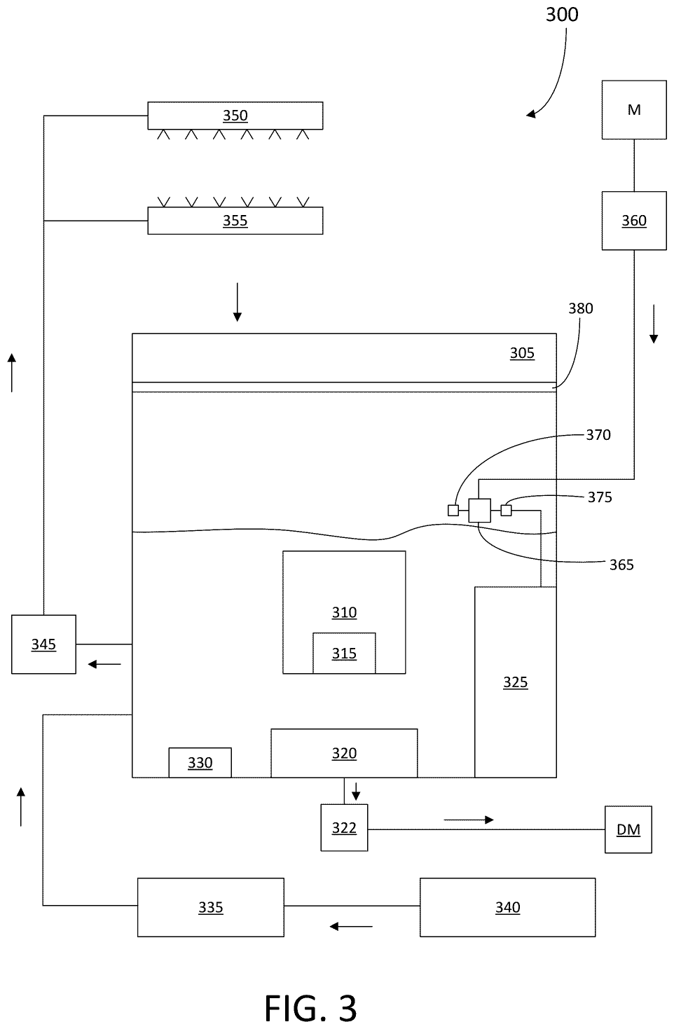

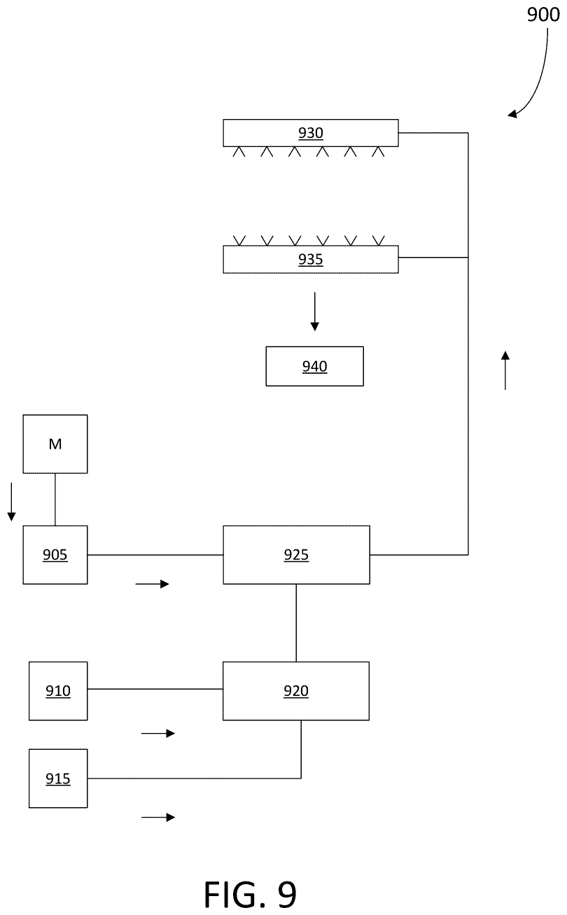

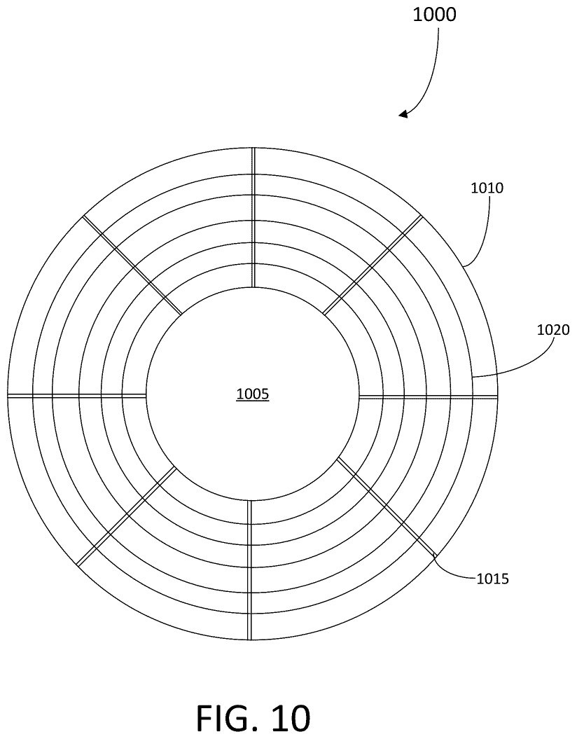

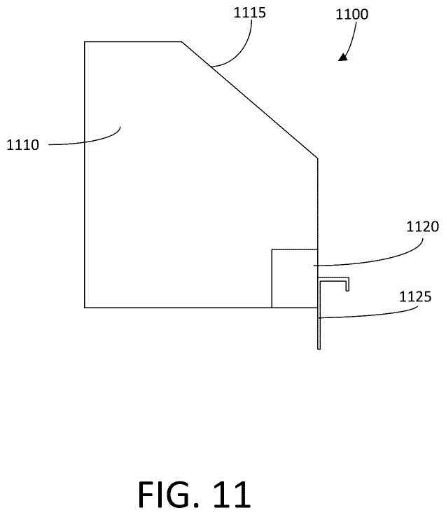

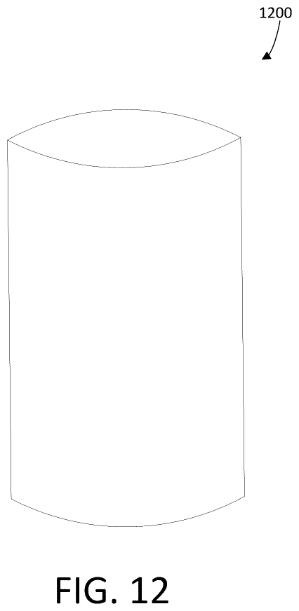

Turning to FIGS. 1 and 2, an on-demand glasswasher is shown and is generally identified by reference numeral 100. The on-demand glasswasher 100 includes a control system 200 (FIG. 2), a wash system 300 (FIG. 3), a rinse system 900 (FIG. 9), a motor and conveyor system 1000 (FIG. 10), a sanitary divider 1100 (FIG. 11), a cylinder 1200 (FIG. 12) and a housing 110 that houses the various components therein. The on-demand glasswasher 100 includes a rotary conveyor and is used to wash glasses such as for example glassware, drinkware, barware, wine glasses, etc. as they travel along the rotary conveyor.

The control system 200 includes at least a microprocessor and a memory device. The memory device is provided to store, amongst other things, instructions that, when executed by the microprocessor, causes the microprocessor to control operation of the on-demand glasswasher 100 and the various components thereof. Example instructions will be described in more detail below.

The wash system 300 is shown in FIG. 3. The wash system 300 includes a wash tank 305, a heater 310, a bi-metal safety 315, a drain 320, a fluid level sensor assembly 325, a thermistor 330, a detergent dispenser 335, an injector 340, a pump 345, upper wash arms 350, lower wash arms 355, a valve 360, a fitting 365, nozzles 370, 375 and a screen 380.

The wash tank 305 is positioned to be readily accessible within the housing 110. For example, a door of the housing 110 may be opened to access the wash tank 305. A bottom portion of the wash tank 305 may be generally kidney-shaped.

The wash tank 305 receives water from water mains M via the valve 360. Put another way, the valve 360 is connected to the water mains and is used to selectively fill the wash tank 305 with water from the water mains M. The valve 360 may be connected to and controlled by the control system 200.

The heater 310 is located within the wash tank 305 and is configured to heat water stored in the wash tank 305. The bi-metal safety 315 is connected to the heater 310 and is configured to monitor a temperature of the heater. In the event that the temperature of the heater 310 goes above a threshold temperature, the bi-metal safety 315 is configured to shut-off the heater. The heater 310 and/or the bi-metal safety 315 may be connected to and controlled by the control system 200.

The drain 320 is located in the bottom of the wash tank 305 and is configured to drain water and/or soap water from the wash tank 305. In one or more embodiments, the drain 320 may be positioned within the kidney-shaped portion of the wash tank 305.

In one or more embodiments, the drain 320 may be connected to a drain pump 322 that may be used to pump the drain water and/or soap water to drain mains DM. The drain 320 and/or drain pump 322 may be connected to and controlled by the control system 200.

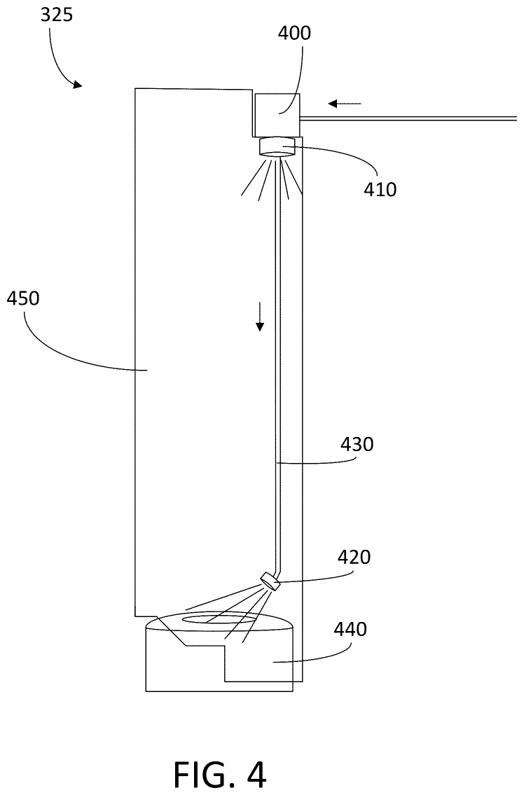

The fluid level sensor assembly 325 is located within the wash tank 305 and is configured to monitor a level of fluid in the wash tank 305. FIG. 4 shows a partial schematic view of the fluid level sensor assembly 325. The fluid level sensor assembly 325 includes a diverter 400 fluidly connected to a first nozzle 410 and fluidly connected to a second nozzle 420 via tubing 430, an ultrasonic sensor assembly 440, and a harbour tube 450.

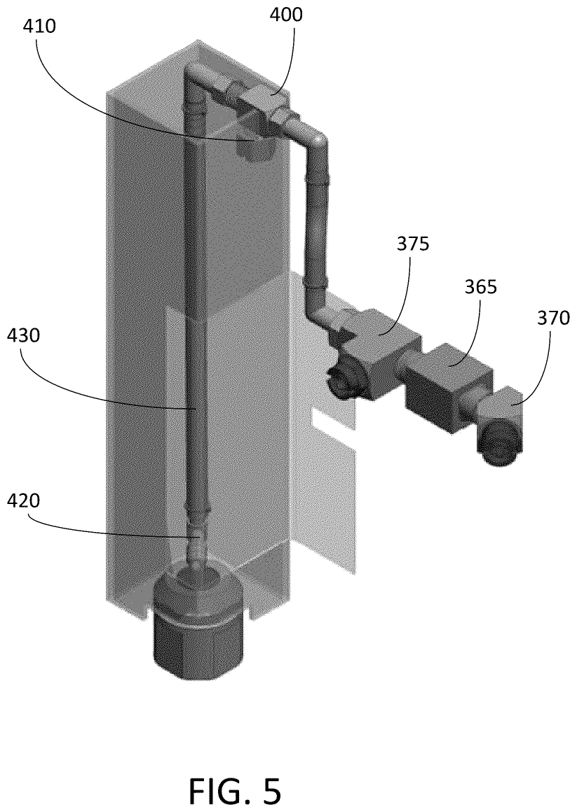

As shown in FIG. 5, the diverter 400 is fluidly connected to the fitting 365 and the nozzle 375 of the wash system 300 and receives water therefrom. The diverter 400 diverts the ingress of water received from the fitting 365 of the wash system 300 to the first nozzle 410 and the second nozzle 420 (via tubing 430).

The first nozzle 410 is fluidly connected to the diverter 400 and receives water therefrom. The first nozzle 410 is positioned to spray water received from the diverter 400 into the harbour tube 450. In one or more embodiments, the first nozzle 410 may be positioned to spray water towards the corners or interior side edges of the harbour tube 450 at a pressure sufficient to remove items or debris that may be stuck to the interior surface of the harbour tube 450. In this manner, the first nozzle 410 may clean an interior surface of the harbour tube while contributing to filling the wash tank 305 with water.

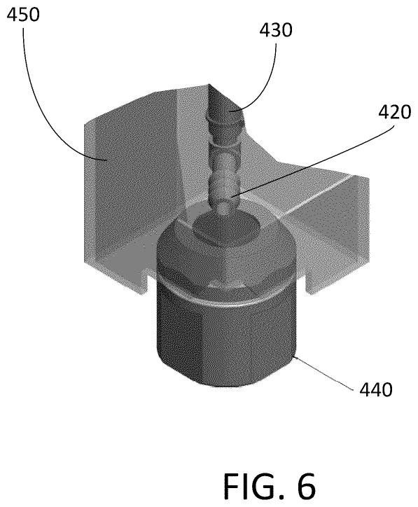

The second nozzle 420 is fluidly connected to the diverter 400 via the tube 430 and receives water therefrom. The tube 430 may be made of a flexible material such as for example rubber and may allow water received from the diverter 400 to travel to the second nozzle 420. As shown in FIG. 6, the second nozzle 420 is positioned to spray water received from the diverter 400 (FIG. 4) via the tube 430 across a surface of the ultrasonic sensor assembly 440 and towards an opening defined in the harbour tube 450. In this manner, the second nozzle 420 may clean the surface of the ultrasonic sensor assembly 440 while contributing to filling the wash tank 305 with water.

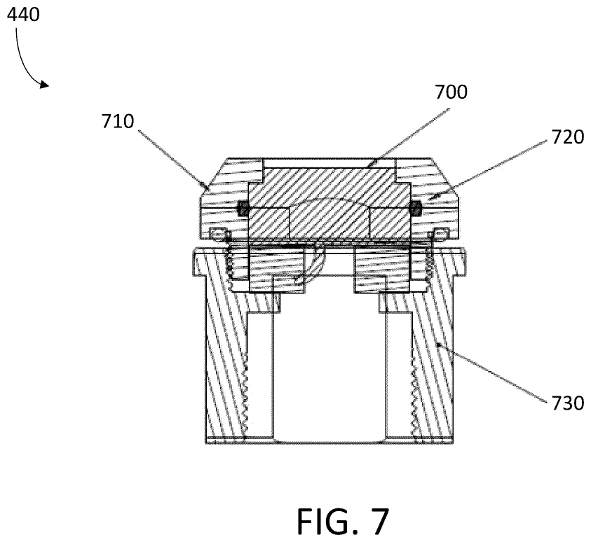

A cross-sectional view of the ultrasonic sensor assembly 440 is shown in FIG. 7. In this embodiment, the ultrasonic sensor assembly 440 includes an ultrasonic sensor 700, a recessed fitting 710, an O-ring 720 and a compression nut 730.

In this embodiment, the ultrasonic sensor 700 includes a piezoelectric crystal and is configured to emit ultrasonic signals at a frequency of approximately 1 MHz.

The recessed fitting 710 receives the ultrasonic sensor 700. Specifically, the recessed fitting 710 includes an opening that is dimensioned to receive and retain the ultrasonic sensor 700. In this manner, the recessed fitting 710 does not interfere with ultrasonic signals emitted by the ultrasonic sensor 700. A bottom portion of the recessed fitting 710 includes threadings that are dimensioned to engage with threadings of the compression nut 730.

The O-ring 720 is positioned to circumscribe the ultrasonic sensor 700 and forms a seal between the ultrasonic sensor 700 and the recessed fitting 710.

As mentioned, the compression nut 730 includes threadings that are dimensioned to engage with the threadings of the recessed fitting 710. Rotation of the compression nut 730 relative to the recessed fitting 710 causes the compression nut 730 to travel towards the recessed fitting 710. In this manner, the ultrasonic sensor 700 is held in place between the compression nut 730 and the recessed fitting 710.

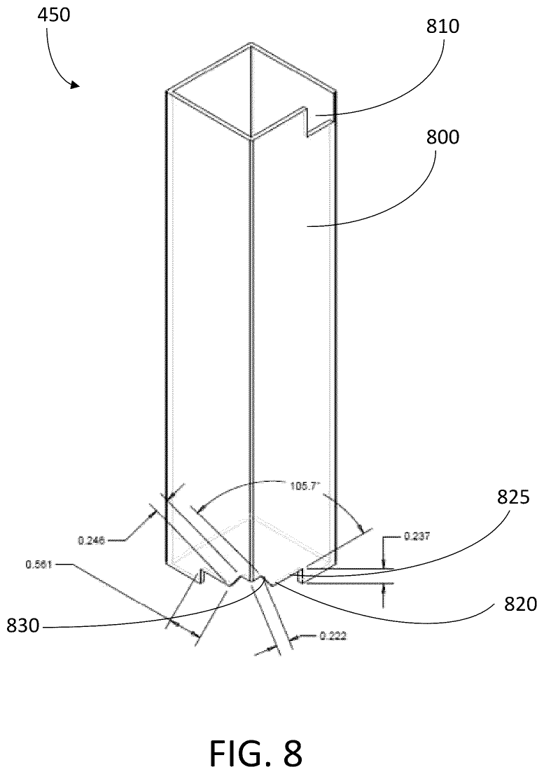

An isometric view of the harbour tube 450 is shown in FIG. 8. The harbour tube 450 includes a hollow body 800 that has a generally square cross-section. In this embodiment, the square cross-section is dimensioned to fit within a corner of the wash tank 305. The hollow body 800 may be made of polypropylene or another rigid material and is dimensioned to fit in the wash tank 305 of the wash system 300. A notch 810 is defined in a top end of the harbour tube 450 and is dimensioned to receive the diverter 400 (as shown in FIGS. 4 and 5).

An opening 820 is defined at a bottom end of the harbour tube 450. In this embodiment, the opening 820 is defined at a bottom corner of the harbour tube 450 between two adjacent sides of the harbour tube 450. On each of the adjacent sides of the harbour tube 450, the opening 820 includes a first section 825 that is defined a first distance from the bottom of the harbour tube 450 and a second section 830 that is defined at a second distance from the bottom of the harbour tube 450, where the second distance is greater than the first distance. The second sections 830 defined on the adjacent sides of the harbour tube 450 connect to one another at the corner of the two adjacent sides of the harbour tube 450. The opening 820 allows fluid/water to travel between the harbour tube 450 and the wash tank 305 of the wash system 300.

The harbour tube 450 acts as a harbour by sheltering or otherwise protecting the ultrasonic sensor 700 from disruptions caused by movement of the fluid or water within the wash tank 305 thereby increasing the accuracy of the ultrasonic sensor 700.

The fluid level sensor assembly 325 is assembled such that the diverter 400 is positioned within the notch 810 of the harbour tube 450. The first nozzle 410 is positioned within the harbour tube 450 adjacent to the diverter 400 and is positioned to spray water received from the diverter 400 into the harbour tube 450. The tube 430 extends from the diverter 400 and is connected to the second nozzle 420 at a location adjacent to the ultrasonic sensor assembly 440. The second nozzle 420 is positioned to spray water received from the diverter 400 (FIG. 4) via the tube 430 across a surface of the ultrasonic sensor assembly 440 and towards the opening 820 defined in the bottom end of the harbour tube 450. The ultrasonic sensor assembly 440 is positioned within the harbour tube 450 at the bottom end thereof such that the ultrasonic sensor 700 emits ultrasonic signals within the harbour tube 450.

During operation, the ultrasonic sensor 700 emits ultrasonic signals generally upwards within the harbour tube 450. The ultrasonic signal is reflected, by the water, back to the ultrasonic sensor 700. The ultrasonic sensor 700 receives the reflected ultrasonic signal and communicates the reflected ultrasonic signal to the control system 200 where it is processed to determine the level of water or fluid in the harbour tube 450 and thus the wash tank 305.

Further during operation, water may be injected into the wash tank 305 via the valve 360. A portion of the water is directed by the fitting 365 to the diverter 400. The diverter 400 diverts the water to the first nozzle 410 and the second nozzle 420. Water expelled by the first nozzle 410 is directed towards sides of the harbour tube 450 and in this manner the water may be used to clean the sides of the harbour tube 450. Water expelled by the second nozzle 420 is directed towards a surface of the ultrasonic sensor assembly 440 and in this manner the water may be used to clean the surface of the ultrasonic sensor assembly 440. Through use of the harbour tube 450, the ultrasonic sensor 700 is generally sheltered from disruptions caused by, for example, moving water. Through use of the first nozzle 410 and the second nozzle 420, debris or other contaminants may be cleared from the harbour tube 450 and/or the ultrasonic sensor assembly or otherwise removed. As such, the accuracy of readings made by the ultrasonic sensor 700 is increased.

Referring back to FIG. 3, the thermistor 330 is located within the wash tank 305 and is configured to monitor a temperature of the water in the wash tank 305. The thermistor 330 may be connected to and controlled by the control system 200.

The detergent dispenser 335 provides detergent to the wash tank 305 via the injector 340. The injector 340 may be connected to and controlled by the control system 200.

Within the wash tank 305, the water contained therein and the detergent are combined to create soap water that may be used to clean one or more objects as they travel along at least a portion of the rotary conveyor. Specifically, the pump 345 is connected to the wash tank 305 and is configured to pump soap water contained in the wash tank 305 to the upper wash arms 350 and the lower wash arms 355.

The upper wash arms 350 and lower wash arms 355 are positioned to dispense the soap water received from the wash tank 305 via the pump 345. Specifically, the upper wash arms 350 and the lower wash arms 355 are positioned above and below the rotary conveyor (not shown), respectively. Each one of the wash arms includes at least one nozzle configured to direct the egress of soap water towards the rotary conveyor (not shown). The at least one nozzle may include a plurality of nozzles. In this manner, soap water from the wash tank 305 is used to clean one or more objects as they travel along the rotary conveyor (not shown).

The fitting 365 is positioned within the wash tank 305 and is fluidly connected to the valve 360. The fitting 365 directs water received from the mains via the valve 360 towards the nozzles 370, 375 and towards the diverter 400.

The nozzles 370, 375 are positioned within the wash tank 305 and direct the egress of water received from the mains via the valve 360 and the fitting 365 into the wash tank 305. The nozzles 370, 375 are positioned within the wash tank 305 at a position above a maximum fill level of the wash tank 305. In this embodiment, the maximum fill level of the wash tank 305 may be six (6) inches (measured from the bottom of the wash tank 305) and as such the nozzles 370, 375 are positioned six-point-five (6.5) inches from the bottom of the wash tank 305, which is 0.5 inches above the maximum fill level of the wash tank 305. Positioning the nozzles 370, 375 above the maximum fill level of the wash tank 305 allows gas within the water to escape and settle and in this manner the water entering the wash tank 305 from the nozzles 370, 375 is clear or non-cloudy and this allows the fluid level sensor assembly 325 to determine a fluid level of the wash tank 305 while the wash tank 305 is being filled.

The screen 380 is positioned between the upper wash arms 350 and the lower wash arms 355 and the wash tank 305. The screen 380 is used to capture or filter debris received from the one or more objects as they are cleaned.

During operation of the wash system 300, the wash tank 305 is selectively filled with a predefined amount of water via the valve 360. The water is directed from the valve 360 to the nozzles 370, 375 and the diverter 400 by the fitting 365. The wash tank 305 is filled with a predefined amount of detergent from the detergent dispenser 335 via the injector 340. The water and the detergent are combined within the wash tank 305 to create soap water. The soap water is heated to a predefined temperature using the heater 310.

As objects travel along a portion of the rotary conveyor, soap water is directed out of the nozzles of the upper wash arms 350 and the lower wash arms 355 and towards the objects. The soap water cleans the objects and excess soap water and any debris from the objects travels through the screen 380 and back into the wash tank 305. As will be described in more detail below, in the event that the amount of soap water in the wash tank 305 drops below a certain level, the control system 200 may perform operations to refill or top-up the wash tank 305 with water and/or detergent. In this manner, the wash system 300 may operate continuously to clean objects as they are placed on the rotary conveyor.

The rinse system 900 is positioned downstream of the wash system 300. Put another way, as objects travel along the rotary conveyor, they pass through the wash system 300 and then pass through the rinse system 900. In this manner, the objects are rinsed by the rinse system 900 after they are washed by the wash system 300.

The rinse system 900 is shown in FIG. 4. The rinse system 900 includes a valve 905, a sanitizer dispenser 910, a rinse-aid dispenser 915, an injector 920, an injection fitting 925, upper rinse arms 930, lower rinse arms 935 and a drain 940.

The rinse system 900 receives water from the water mains M via the valve 905. It will be appreciated that the water received from the water mains M may be cold water, that is, the water is not heated. The water travels to the injection fitting 925. The valve 905 may be connected to and controlled by the control system 200.

The sanitizer dispenser 910 provides sanitizer to the injection fitting 925 via the injector 920 and similarly the rinse-aid dispenser 915 provides rinse-aid to the injection fitting 925 via the injector 920. The injector 920 may be connected to and controlled by the control system 200. The injector 920 may be the same injector as the injector 340 of the wash system 300.

The injection fitting 925 receives the water from the water mains via the valve 905, the sanitizer from the sanitizer dispenser 910 via the injector 920, and rinse-aid from the rinse-aid dispenser 915 via the injector 920 and provides the mixture to the upper rinse arms 930 and the lower rinse arms 935.

The upper rinse arms 930 and the lower rinse arms 935 are positioned to dispense the mixture received from the injection fitting 925. Specifically, the upper rinse arms 930 and the lower rinse arms 935 are positioned above and below the rotary conveyor (not shown), respectively. Each one of the rinse arms includes at least one nozzle configured to direct the egress of the mixture towards the rotary conveyor (not shown). The at least one nozzle may include a plurality of nozzles. In this manner, the mixture of water, sanitizer and rinse-aid is used to rinse one or more objects as they travel along the rotary conveyor (not shown).

The drain 940 is located below the upper rinse arms 930 and the lower rinse arms 935. The drain 940 is configured to drain the mixture from the rinse system 900. The drain 940 may be connected to drain mains and as such the mixture received by the drain 940 may be drained out through the drain mains. Similar to the drain 32, the drain 940 may be connected to a drain pump which may be used to pump the mixture to the drain mains. The drain 940 and/or the drain pump may be connected to and controlled by the control system 200. A screen may be provided to capture or filter debris received from the one or more objects as they are rinsed and the screen may be positioned between the upper rinse arms 930 and the lower rinse arms 935 and the drain 940.

During operation of the rinse system 900, the injection fitting 925 receives the water from the water mains via the valve 905, the sanitizer from the sanitizer dispenser 910 via the injector 920, and rinse-aid from the rinse-aid dispenser 915 via the injector 920 and provides the mixture to the upper rinse arms 930 and the lower rinse arms 935.

After being washed by the wash system 300, objects travel along a portion of the rotary conveyor towards the rinse system 900. As the objects travel through the rinse system 900, the mixture is directed out of the nozzles of the upper rinse arms 930 and the lower rinse arms 935 towards the objects. The mixture rinses the objects and excess mixture travels down through the drain 940.

Turning to FIG. 10, the motor and conveyor system 1000 are shown. The motor and conveyor system 1000 includes a motor 1005 and a rotary conveyor 1010. In this embodiment, the motor 1005 is a drive motor that is connected to the rotary conveyor 1010 such that rotation of the motor 1005 causes rotation of the rotary conveyor 1010. The motor 1005 is connected to and controlled by the control system 200.

In this embodiment, the rotary conveyor 510 comprises a plurality of concentric ribs 1015 and a plurality of radially extending vanes 1020. The radially extending vanes 1020 are connected to the concentric ribs 1015.

Although not shown in FIG. 10, the motor and conveyor system 1000 may additionally include one or more components that may be used to control the operation thereof. For example, the motor and conveyor system 1000 may include a sensor such as a proximity sensor that may be used to detect the presence of one or more objects on the rotary conveyor 1010 which in turn may be used to control the operation of the motor 1005. For example, the sensor may communicate with the control system 200 to selectively start the motor 1005 when no object is detected in proximity of the sensor and may selectively stop the motor 1005 when an object is detected in proximity of the sensor.

The sanitary divider 1100 is shown in FIG. 11. In this embodiment, the sanitary divider 1100 includes a panel 1110 that is made of a rigid material such as for example plastic and the rigid material may be transparent. The panel 1110 is generally rectangular and includes a tapered section 1115 at a top side thereof. The tapered section 1115 extends downward from the top surface to a side of the panel 1110. The sanitary divider 1100 includes a bracket 1120 that is dimensioned to receive and retain the panel 1110. Specifically, the bracket 1120 includes parallel spaced apart sections that define an opening to receive and retain a portion of the panel 1110. Fasteners such as screws may be used to secure the panel 1110 in the bracket 1120. The bracket 1120 includes a hook 1125 that is dimensioned to connect to a portion of the housing 110.

In one or more embodiments, the sanitary divider 1100 divides or separates a load zone and a clean zone of the on-demand glasswasher 100 and this may ensure any dirt or debris from dirty or unwashed glasses does not contact or soil clean classes located in the clean zone.

The cylinder 1200 is shown in FIG. 12. The cylinder 1200 may be made of a material that reflects ultrasound signals emitted by an ultrasonic sensor. The cylinder 1200 may be made of stainless steel. The cylinder 1200 is dimensioned to be circumscribed by the rotary conveyor 510. Specifically, the cylinder 1200 is dimensioned to be positioned within the center of the rotary conveyor 510 such that at least a portion of the cylinder 1200 extends above the rotary conveyor 510 while still allowing the rotary conveyor 510 to rotate. The rounded surface of the cylinder 1200 prevents or otherwise minimizes the risk of glasses falling over or being scratched should they come into contact therewith.

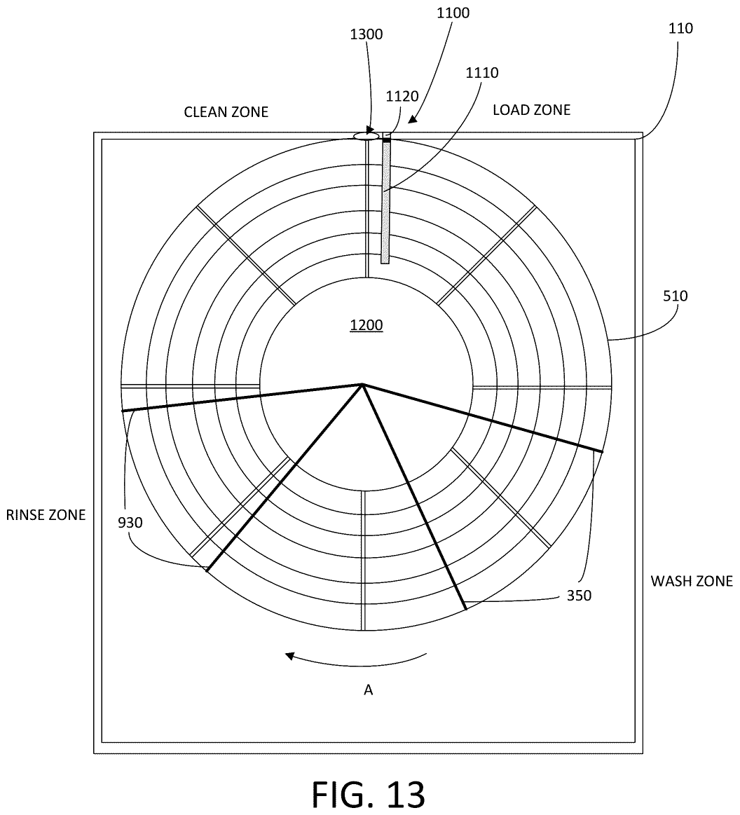

Assembly of various components of the on-demand glasswasher 100 will now be described with respect to FIG. 13 which is a top plan view of the on-demand glasswasher 100. It will be appreciated that the on-demand glasswasher 100 is shown without a top covering for illustrative purposes only.

The motor and conveyor system 1000 are positioned within the housing 110. The upper wash arms 350 and the upper rinse arms 930 are shown. It will be appreciated that the lower wash arms 355 and the lower rinse arms 935 are not visible in the top plan view of FIG. 13, however the lower wash arms 355 are located directly beneath the upper wash arms 350 and the lower rinse arms 935 are located directly beneath the upper rinse arms 930.

As mentioned, the motor and conveyor system 1000 may additionally include one or more components that may be used to control the operation thereof. In the example shown in FIG. 13, the motor and conveyor system 1000 includes a sensor 1300 that is positioned within the housing 110 of the on-demand glasswasher 100.

The hook 1125 of the sanitary divider 1100 connects to a portion of the housing 110. In the example shown in FIG. 13, the sanitary divider 1100 is positioned adjacent to the sensor 1300 of the motor and conveyor system 1000 and such that the panel 1110 extends into the housing 110.

The cylinder 1200 is positioned within the center of the rotary conveyor 510 such that at least a portion of the cylinder 1200 extends above the rotary conveyor 510 while still allowing the rotary conveyor 510 to rotate.

The on-demand glasswasher 100 includes four zones. A load zone is defined at a first end of the housing 110. The load zone may be defined on a particular side of the sanitary divider 1100. Specifically, the load zone may be defined such that any objects placed on the rotary conveyor 510 travel in a direction away from the sanitary divider 1100. During use, a user places objects to be cleaned onto the rotary conveyor 510 at a location that corresponds to the load zone.

A wash zone is defined intermediate the upper wash arms 350. The wash zone is downstream of the load zone. As objects travel along the rotary conveyor (in the direction indicated by arrow A in FIG. 13) into the wash zone, the objects are washed by the wash system 300 in manners described herein.

A rinse zone is defined intermediate the upper rinse arms 930. The rinse zone is downstream of the wash zone. As objects travel along the rotary conveyor (in the direction indicated by arrow A in FIG. 13) into the rinse zone, the objects are rinsed by the rinse system 900 in manners described herein.

A clean zone is defined at the front end of the housing 110. The clean zone is downstream of the rinse zone. The clean zone may be defined on a second side of the sanitary divider 1100. In this manner, the sanitary divider 1100 divides or separates the load zone and the clean zone and this may ensure any dirt or debris from dirty or unwashed glasses does not contact or soil clean glasses located in the clean zone. During use, once objects have been washed and rinsed, they remain in the clean zone until the user removes them from the rotary conveyor 510.

As mentioned, the control system 200 includes at least a microprocessor and a memory device. The memory device is provided to store, amongst other things, instructions that, when executed by the microprocessor, causes the microprocessor to control operation of the on-demand glasswasher 100 and the various components thereof.

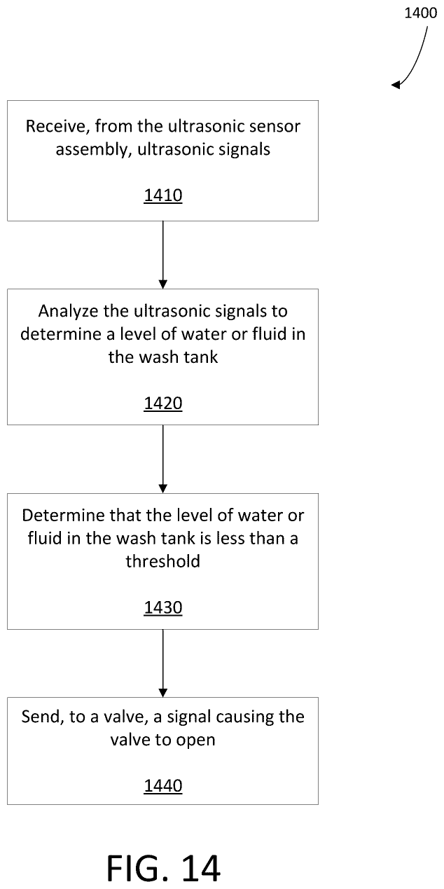

Reference is made to FIG. 14, which illustrates, in flowchart form, a method 1400 for processing ultrasonic signals to fill a wash tank. The method 1400 may be implemented by the microprocessor. For example, a memory device may be coupled to the microprocessor and may store processor-executable instructions which, when executed by the microprocessor, cause the microprocessor to carry out the method 1400.

The method 1400 includes receiving, from the ultrasonic sensor assembly, ultrasonic signals (step 1410).

In this embodiment, the ultrasonic sensor assembly 440, specifically the ultrasonic sensor 700, emits ultrasonic signals within the harbour tube 450. The ultrasonic signals are reflected and returned back to the ultrasonic sensor 700. The ultrasonic signals received by the ultrasonic sensor 700 are communicated to the microprocessor.

The method 1400 includes analyzing the ultrasonic signals to determine a level of water or fluid in the wash tank (step 1420).

The microprocessor analyzes the ultrasonic signals to determine the level of water or fluid in the wash tank. For example, the microprocessor may determine the level of water or fluid in the wash tank by finding a distance between the ultrasonic sensor and the surface of the water. Specifically, the ultrasonic sensor may transmit ultrasonic pulses that are reflected back and the travel time of the pulse (the echo) may be measured and used to determine the level of water or fluid in the wash tank. The analysis may include applying one or more filtering algorithms to the ultrasonic signals. For example, the ultrasonic signals may be passed through one or more filters to remove noise, etc. and this may be done by instructions executed by the microprocessor. It will be appreciated that in one or more embodiments, the ultrasonic sensor assembly 440 may additionally or alternatively include a processor that may be used to filter the signals.

The method 1400 includes determining that the level of water or fluid in the wash tank is less than a threshold (step 1430).

In this embodiment, the threshold may be a maximum fill level of the wash tank which may be, for example, six (6) inches (measured from a bottom of the wash tank). The microprocessor compares the level of water or fluid in the wash tank to a threshold to ensure there is sufficient water or fluid in the wash tank.

Responsive to determining that the level of water or fluid in the wash tank is less than the threshold, the method 1400 includes sending, to a valve, a signal causing the valve to open (step 1440). By opening the valve, water is received from the mains (see FIG. 3) and used to fill the wash tank 305.

It will be appreciated that the level of water or fluid in the wash tank may be continuously monitored and compared to the threshold and when it is determined that the level of water or fluid in the wash tank is equal to or above the threshold, the microprocessor may send a signal to close the valve. For example, when filling the tank, the level of water or fluid in the wash tank may be continuously monitored and when the level of water or fluid in the wash tank is equal to the threshold the microprocessor may send a signal to close the valve.

In one or more embodiments, the microprocessor may include a fluid level prediction engine that may be used to generate a prediction as to the level of water or fluid in the wash tank. For example, the fluid level prediction engine may obtain an approximate flow rate of water used to fill the wash tank and may generate a prediction as to what the fluid level in the wash tank should be. The fluid level prediction engine may monitor the rate of decline in the fluid level during use and may store this data as historical fluid level data. The fluid level prediction engine may determine a rate of decline of the fluid level during normal operation and may determine a fill rate based on this rate of decline. As another example, the fluid level prediction engine may obtain a time required to fill the wash tank and may generate a prediction as to what the fluid level in the wash tank should be based on how much time the valve has been open. The microprocessor may compare the level of water or fluid in the wash tank as determined by processing the ultrasonic signals to the prediction generated by the fluid level prediction engine and in the event that the difference between the level of water or fluid in the wash tank as determined by processing the ultrasonic signals and the prediction generated by the fluid level prediction engine is greater than a threshold, the microprocessor may determine that an error has occurred and may perform one or more operations such as for example generating an alert, shutting off the valve, etc.

It will be appreciated that the microprocessor may perform one or more additional operations based on the level of water or fluid in the wash tank. For example, the microprocessor may perform operations to start or stop the heater 310 that is positioned in the wash tank 305. As another example, the microprocessor may perform operations to drain the fluid in the wash tank 305.

In accordance with the methods described herein, the microprocessor together with the ultrasonic sensor ensures sufficient water is maintained in the wash tank of the on-demand glasswasher 100. As described herein, through use of the nozzles and harbour tube, the accuracy of the ultrasonic sensor is increased.

Although in embodiments the wash system is described as including two nozzles positioned within the wash tank and directing the egress of water received from the mains via the valve and fitting into the wash tank, it will be appreciated that the wash system may only include a single nozzle or may include a plurality of nozzles.

Although in embodiments the fluid level sensor assembly is described as including includes a diverter fluidly connected to a first nozzle and fluidly connected to a second nozzle via tubing, an ultrasonic sensor assembly, and a harbour tube, those skilled in the art will appreciate that alternatives are available. In one or more embodiments, the fluid level sensor assembly may include an intermediary or settling chamber that may be used to allow gas within the water to escape and settle such that water entering the harbour tube is clear or non-cloud to increase the accuracy of the fluid level sensor assembly 325

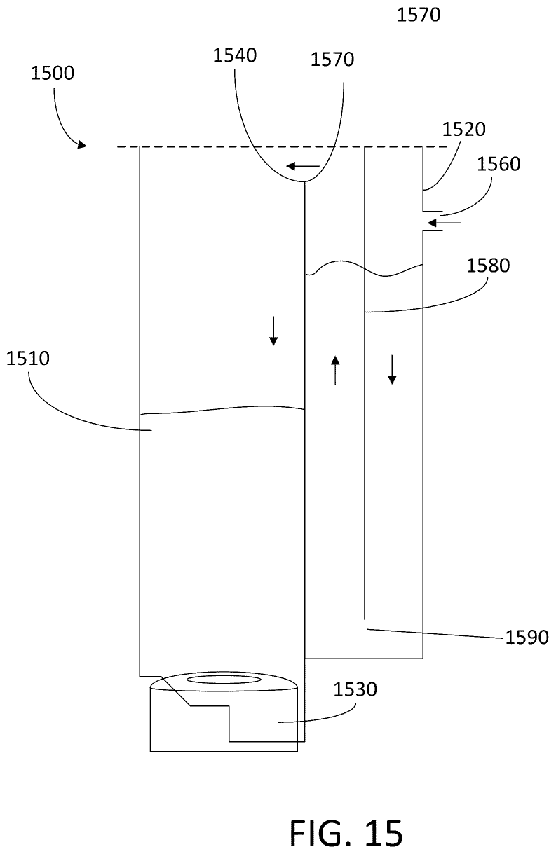

An embodiment of a fluid level sensor assembly 1500 that includes a harbour tube 1510 fluidly connected to an intermediary or settling chamber 1520 and an ultrasonic sensor assembly 1530 is shown in a cross-sectional view in FIG. 15.

The harbour tube 1510 is generally similar to the harbour tube 450 described herein with the following exceptions. In this embodiment, the harbour tube 1510 does not include a notch defined in a top end thereof. Rather, the harbour tube 1510 includes an opening or notch 1540 that is located adjacent to the intermediary or settling chamber 1520.

The intermediary or settling chamber 1520 includes an opening 1560 that is configured to direct the egress of fluid received from a valve or a nozzle (not shown). The opening 1560 may be an inlet and is defined on a side of the intermediary chamber 1520 opposite the harbour tube 1510. An opening or notch 1570 is defined on the other side of the intermediary chamber 1520 and is aligned with the opening or notch 1540 of the harbour tube 1510. The opening or notch 1570 and the opening or notch 1540 may provide an outlet that permits the egress of fluid from the intermediary or settling chamber 1520 to the harbour tube 1510. An interior wall 1580 divides the intermediary chamber 1520 into two channels. Put another way, the interior wall 1580 extends into the intermediary chamber and defines a serpentine channel that fluidly connects the opening 1560 to the opening or notch 1570. Specifically, the interior wall 1580 leaves a gap 1590 allowing fluid to travel from the inlet to the outlet.

The ultrasonic sensor assembly 1530 is generally similar to the ultrasonic sensor assembly 440 described herein.

During operation, water or fluid is received from a valve or nozzle via the opening 1560. As water fills the intermediary or settling chamber 1520, the water or fluid travels in a serpentine path towards the opening or notch 1570. The water or fluid is directed to the harbour tube 1510 by way of the opening or notch 1570 and the opening or notch 1540 and fills the harbour tube where the ultrasonic sensor assembly 440 may emit ultrasonic signals that may be processed to determine the level of fluid. Through use of the intermediary chamber, gas that may be contained in the water or fluid may escape from the water or fluid before it is directed into the harbour tube 1510. In this manner, the water or fluid entering the harbour tube 1510 is clear or non-cloudy and this allows the fluid level sensor assembly to determine a fluid level.

It will be appreciated that in one or more embodiments the intermediary or settling chamber 1520 and the harbour tube 1510 may be a unitary and as such the side of the intermediary or settling chamber 1520 adjacent to the harbour tube 1510 may also be a side of the harbour tube 1510. Put another way, the harbour tube 1510 and the intermediary or settling chamber 1520 may share a common side or wall.

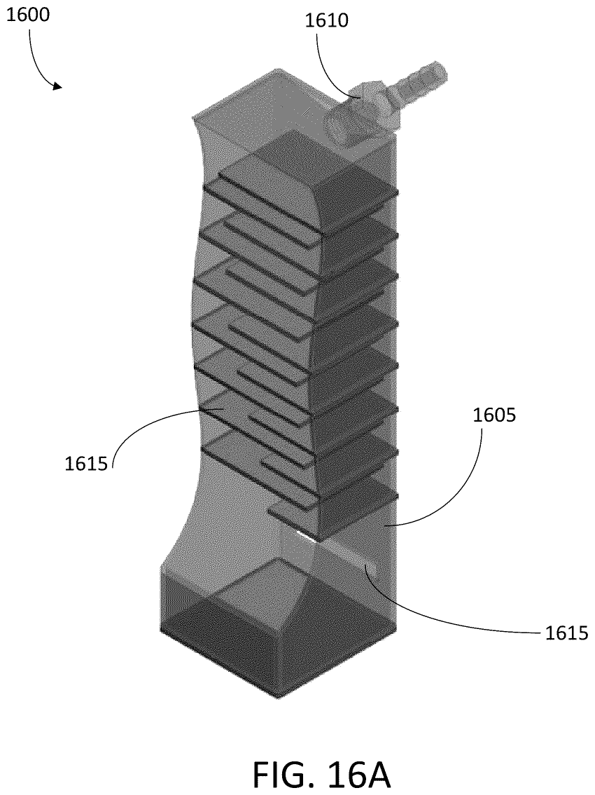

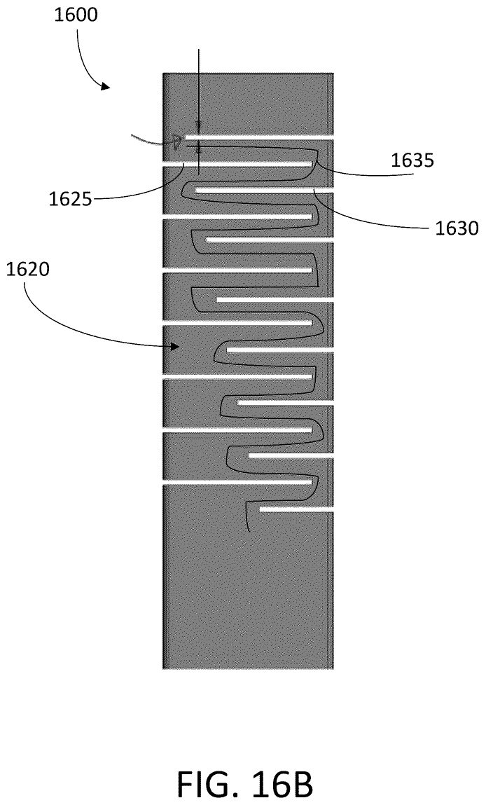

As mentioned, in one or more embodiments, the fluid level sensor assembly may include an intermediary or settling chamber that may be used to allow gas within the water to escape and settle such that water entering the harbour tube is clear or non-cloud to increase the accuracy of the fluid level sensor assembly 325. Another example settling chamber 1600 is shown in FIGS. 16A and 16B.

The settling chamber 1600 includes a hollow housing 1605, an inlet 1610, an outlet 1615 and interior wall structure 1620.

The hollow housing 1605 may be made of polypropylene or another rigid material. The inlet 1610 is defined at a first end of the housing 1605 and the outlet 1615 is defined at a second end of the housing 1605. The inlet 1610 may include threadings or other connecting mechanism that is configured to connect to a nozzle (such as for example one of the nozzles 370, 375) and this may be by way of a fitting. The fitting may be similar to the fitting 365 described herein. The outlet 1615 may be in fluid communication with an inlet of a harbour tube. The harbour tube may be similar to that described herein.

As best shown in FIG. 16B, the interior wall structure 1620 includes a first set of equally spaced-apart walls 1625. The first set of equally-spaced apart walls 1625 are connected to a first side of the housing 1605 and extend towards a second side of the housing 1605. The first set of equally-spaced apart walls 1625 have the same length. The interior wall structure 1620 includes a second set of equally spaced-apart walls 1630. The second set of equally spaced-apart walls 1630 are connected to a second side of the housing 1605 and extend towards the first side of the housing 1605. The second set of equally-spaced apart walls 1630 have cascading lengths such that the wall positioned closest to the inlet 1610 (shown FIG. 16A) has the greatest length (compared to the other walls of the second set of equally-spaced apart walls 1630) and the wall positioned closest to the outlet 1615 (shown in FIG. 16A) has the shortest length (compared to the other walls of the second set of equally-spaced apart walls 1630).

The first set of equally-spaced apart walls 1625 and the second set of equally-spaced apart walls 1630 are offset from one another and in this manner the interior wall structure 1620 defines a serpentine channel 1635 that directs the ingress of water received from the inlet 1610, through the serpentine channel, towards the outlet 1615. The serpentine channel 1635 allows the water to settle (for example, by letting gasses escape from the water) as the water travels therethrough and this may be done prior to the water entering the harbour tube.

The water may travel out of the outlet 1615 towards an inlet of a harbour tube which may be similar to that described herein.

As mentioned, in one or more embodiments, the microprocessor may include a fluid level prediction engine that may be used to generate a prediction as to the level of water or fluid in the wash tank. For example, the fluid level prediction engine may obtain an approximate flow rate of water used to fill the wash tank and may generate a prediction as to what the fluid level in the wash tank should be. The fluid level prediction engine may monitor the rate of decline in the fluid level during use and may store this data as historical fluid level data. The fluid level prediction engine may determine a rate of decline of the fluid level during normal operation and may determine a fill rate based on this rate of decline. As another example, the fluid level prediction engine may obtain a time required to fill the wash tank and may generate a prediction as to what the fluid level in the wash tank should be based on how much time the valve has been open. The microprocessor may compare the level of water or fluid in the wash tank as determined by processing the ultrasonic signals to the prediction generated by the fluid level prediction engine and in the event that the difference between the level of water or fluid in the wash tank as determined by processing the ultrasonic signals and the prediction generated by the fluid level prediction engine is greater than a threshold, the microprocessor may determine that an error has occurred and may perform one or more operations such as for example generating an alert, shutting off the valve, etc.

In one or more embodiments, the microprocessor may monitor the fluid level, wash pump, hot water, ultrasonic signal echo, fluid level display counts and/or fluid signal quality signals obtained during use of the on-demand glasswasher and may perform operations in response thereto.

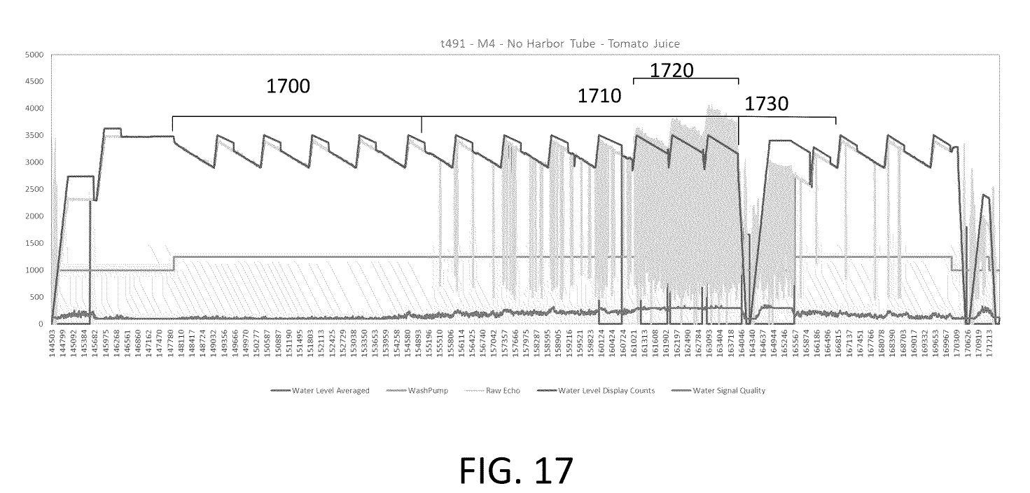

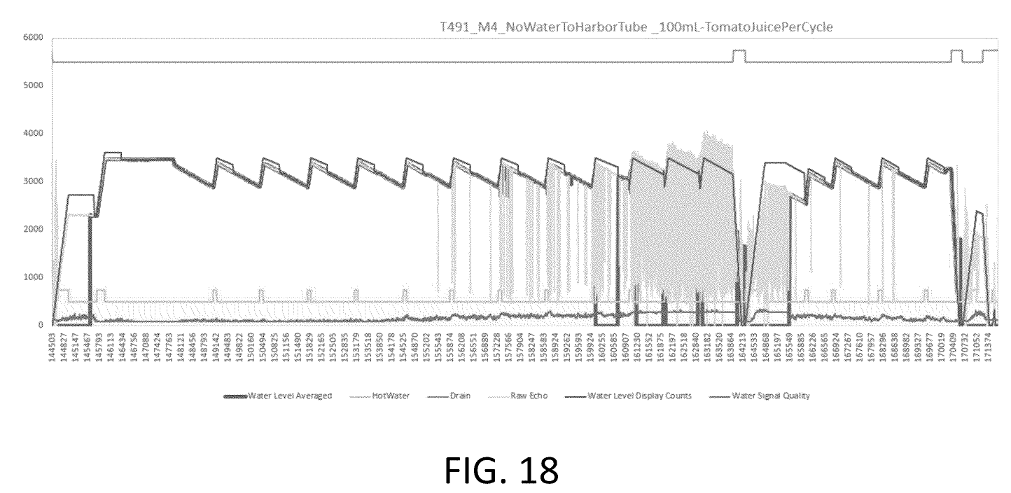

In one or more embodiments, the microprocessor and the ultrasonic sensor may perform operations that include turbidity sensor operations. FIGS. 17 and 18 are graphs showing example fluid level, wash pump, echo, fluid level display counts and fluid signal quality signals obtained during use of an on-demand glasswasher and in response to control by the microprocessor. As can be seen in FIG. 17, during operation of the one-demand glasswasher, the microprocessor performs operations to continuously maintain a fluid level (similar to that described above with reference to FIG. 14). An example is shown on FIG. 17 as element 1700. Over time, the fluid within the wash tank may become dirty and unclear and as such the amount of ultrasonic signals received by the ultrasonic sensor may decrease. Put another way, the measure of ultrasonic signal echo may decrease. As such, signals received by the ultrasonic sensor may be difficult or unclear to process. An example of a decrease in the ultrasonic signal echo is shown on FIG. 17 as element 1710.

The microprocessor may engage the fluid level prediction engine to determine what the fluid level in the wash tank should be and may continue to operate to maintain a fluid level, even though the ultrasonic signal echo has decreased. The microprocessor may continue to operate to maintain the fluid level as long as at least one ultrasonic signal is being received within a certain period (such as for example ninety seconds).

In one or more embodiments, the microprocessor may determine that no ultrasonic signals are being received within a certain period (such as for example every ninety seconds) and in response the microprocessor may initiate a wash refresh sequence. An example of no ultrasonic signals being received within a certain period of time is shown in FIG. 17 as element 1720 and the wash refresh sequence is shown as element 1730. The wash refresh sequence may include stopping the motor and conveyor, sending a signal to open the drain to drain out all fluid in the wash tank, close the drain, open the valves to fill the wash tank, then resume normal operation.

In one or more embodiments, the microprocessor may perform operations to drain an amount of fluid out of the wash tank and this may be done based on a contamination level indicating how dirty or unclear the fluid in the wash tank is predicted to be and this may be done based on the ultrasonic signal echo. In one or more embodiments, the contamination level may be compared to one or more thresholds and this may cause the microprocessor to perform one or more operations. The one or more thresholds may be set or adjusted by a user.

As an example, when at least 90% of the ultrasonic signals emitted by the ultrasonic sensor are received back, it may be determined that the fluid in the wash tank is clean. When 70% to 90% of the ultrasonic signals emitted by the ultrasonic sensor are received back, it may be determined that the fluid in the wash tank is lightly soiled and the microprocessor may perform operations to drain out approximately half a litre of fluid and to fill the wash tank with half a litre of fresh water. When 50% to 70% of the ultrasonic signals emitted by the ultrasonic sensor are received back, it may be determined that the fluid in the wash tank is mediumly soiled and the microprocessor may perform operations to drain out approximately one litre of fluid and to fill the wash tank with one litre of fresh water. When 20% to 50% of the ultrasonic signals emitted by the ultrasonic sensor are received back, it may be determined that the fluid in the wash tank is heavily soiled and the microprocessor may perform operations to drain out approximately one and a half litres of fluid and to fill the wash tank with one and a half litres of fresh water. When less than 20% of the ultrasonic signals emitted by the ultrasonic sensor are received back, it may be determined that the fluid in the wash tank is very heavily soiled and the microprocessor may perform operations to drain out the entire wash tank and to refill the wash tank. As mentioned, the thresholds used to indicate the soil level of the wash tank may be adjusted.

In one or more embodiments, the microprocessor may include a buffer time that may be used to determine whether or not to operate according to the ultrasonic signals or to operate according to the fluid prediction engine. For example, the microprocessor may require at least 50% of the ultrasonic signals emitted by the ultrasonic sensor to be received back to operate according to the ultrasonic signals. If less than 50% of the ultrasonic signals emitted by the ultrasonic sensor are received back, the microprocessor may operate according to the fluid prediction engine. The microprocessor may only rely on the fluid prediction engine for a period of time before performing a full wash refresh cycle.

Although embodiments of the fluid level sensor assembly are described as measuring a level of water or fluid within a wash tank of an on-demand glasswasher, it will be appreciated that the fluid level sensor assembly may be used to measure different types of fluid in different settings. For example, the fluid level sensor assembly may be used to measure a level of water and/or fluid within a wash tank of a residential dishwasher. Other types of fluid may include, for example, well water, oil, salt water, soap, detergent, etc.

As noted, certain adaptations and modifications of the described embodiments can be made. Therefore, the above discussed embodiments are considered to be illustrative and not restrictive.

What is claimed is:

1. An on-demand glasswasher comprising:
a wash tank;
a fluid level sensor assembly that includes an ultrasonic sensor assembly positioned within the wash tank;
at least one microprocessor connected to the ultrasonic sensor assembly; and
a memory device coupled to the at least one microprocessor, the memory device storing processor-executable instructions which, when executed by the at least one microprocessor, configure the microprocessor to:
receive, from the ultrasonic sensor assembly, ultrasonic signals; and
analyze the ultrasonic signals to determine a level of fluid in the wash tank.

2. The on-demand glasswasher of claim 1, wherein the processor-executable instructions, when executed by the at least one microprocessor, further configure the at least one microprocessor to:
compare the level of fluid in the wash tank to a threshold; and
responsive to determining that the level of fluid in the wash tank is less than the threshold, send a signal causing a valve to open to fill the wash tank.

3. The on-demand glasswasher of claim 1, wherein the processor-executable instructions, when executed by the at least one microprocessor, further configure the at least one microprocessor to:
compare the level of fluid in the wash tank to a threshold; and
responsive to determining that the level of fluid in the wash tank is equal to or greater than the threshold, send a signal causing a valve to close to stop filling the wash tank.

4. The on-demand glasswasher of claim 1, wherein the processor-executable instructions, when executed by the at least one microprocessor, further configure the at least one microprocessor to:
engage a fluid level prediction engine to predict a level of fluid in the wash tank;
determine that a difference between the level of fluid in the wash tank and the predicted level of fluid in the wash tank is greater than a threshold; and
responsive to determining that the difference between the level of fluid in the wash tank and the predicted level of fluid in the wash tank is greater than the threshold, perform at least one of sending a signal causing a valve to close or sending a signal to output an alert.

5. The on-demand glasswasher of claim 4, wherein the fluid level prediction engine predicts the level of fluid in the wash tank based on at least one of time and flow rate.

6. The on-demand glasswasher of claim 1, wherein the processor-executable instructions, when executed by the at least one microprocessor, further configure the at least one microprocessor to:
analyze the ultrasonic signals to determine a contamination level of the fluid in the wash tank;
determine that the contamination level is greater than a threshold; and
responsive to determining that the contamination level is greater than the threshold, send one or more signals to perform a wash refresh sequence.

7. The on-demand glasswasher of claim 1, wherein when performing the wash refresh sequence, the processor-executable instructions, when executed by the at least one microprocessor, further configure the at least one microprocessor to:
send a signal to halt operation of the on-demand glass washer;
send a signal to open a drain to drain out fluid from the wash tank;
send a signal to close the drain;
send a signal to open one or more valves to fill the wash tank;
determine that a level of fluid in the wash tank is equal to a threshold;
send a signal to close the one or more valves; and
send a signal to resume normal operation of the on-demand glass washer.

8. The on-demand glasswasher of claim 1, wherein the ultrasonic sensor assembly operates as a turbidity sensor to determine a soil level of fluid in the wash tank.

9. The on-demand glasswasher of claim 1, wherein the processor-executable instructions, when executed by the at least one microprocessor, further configure the at least one microprocessor to:
determine that a quality of the ultrasonic signals or an amount of the ultrasonic signals received has decreased;
responsive to determining that the quality of the ultrasonic signals or the amount of the ultrasonic signals has decreased, send a signal to drain an amount of fluid from the wash tank; and
responsive to draining the amount of fluid, send a signal to fill the wash tank with the amount of fluid.

10. The on-demand glasswasher of claim 9, wherein the amount of fluid drained from the wash tank is dependent on an approximate percentage of ultrasonic signals received.

11. The on-demand glasswasher of claim 9, wherein the processor-executable instructions, when executed by the at least one microprocessor, further configure the at least one microprocessor to:
determine a soil level of the fluid in the wash tank based on the quality of the ultrasonic signals or the amount of the ultrasonic signals.

12. The on-demand glasswasher of claim 1, further comprising at least one nozzle positioned above the wash tank at a height greater than a maximum fill level of the wash tank, the at least one nozzle in fluid communication with a valve to selectively fill the wash tank with fluid.

13. The on-demand glasswasher of claim 1, wherein the fluid level sensor assembly further comprises a harbour tube located within the wash tank, wherein the ultrasonic sensor assembly is positioned within the harbour tube.

14. The on-demand glasswasher of claim 13, wherein the fluid level sensor assembly further comprises an intermediary chamber that includes an inlet for receiving fluid from a fluid source and an outlet in fluid communication with the harbour tube for directing egress of fluid from the intermediary chamber to the harbour tube.

15. The on-demand glasswasher of claim 14, wherein the intermediary chamber includes an interior wall defining a serpentine fluid channel between the inlet and the outlet.

16. A fluid level sensor assembly comprising:
a harbour tube having a notch defined in a first end thereof; and
an ultrasonic sensor assembly positioned within the harbour tube adjacent to the first end thereof.

17. The fluid level sensor assembly of claim 16, wherein the ultrasonic sensor assembly emits ultrasonic signals from the first end of the harbour tube towards a second end of the harbour tube.

18. The fluid level sensor assembly of claim 17, wherein the ultrasonic sensor assembly receives reflected ultrasonic signals and communicates the received reflected ultrasonic signals to a microprocessor for processing to determine a fluid level within the harbour tube.

19. The fluid level sensor assembly of claim 16, wherein the fluid level sensor assembly further comprises an intermediary chamber that includes an inlet that receives fluid from a fluid source and an outlet in fluid communication with the harbour tube that directs egress of fluid from the intermediary chamber to the harbour tube.

20. The fluid level sensor assembly of claim 19, wherein the intermediary chamber includes an interior wall defining a serpentine fluid channel between the inlet and the outlet.
